(19) United States
(12) Patent Application Publication
(10) Pub. No.: US 2015/0076226 A1
(43) Pub. Date: Mar. 19, 2015

(54) CREDIT CARD TERMINAL

(71) Applicant: POS TECH SOLUTIONS LLC, Albuquerque, NM (US)

(72) Inventor: William Robert Dolson, Albuquerque, NM (US)

(73) Assignee: POS TECH SOLUTIONS LLC, Albuquerque, NM (US)

(21) Appl. No.: 14/229,293

(22) Filed: Mar. 28, 2014

Related U.S. Application Data
(60) Provisional application No. 61/877,690, filed on Sep. 13, 2013.

(51) Int. Cl. G06Q 20/18; G06Q 20/16

(52) U.S. Cl. CPC G06Q 20/18; G06Q 20/16
USPC 235/381; 235/380

(57) ABSTRACT

An upgrade card system capable of replacing a prior art credit card terminal system is disclosed. The upgrade card system provides for expanded functionality compared to the prior art credit card terminal system for accepting fleet card payments and providing for additional reports, alerts and different delivery mechanisms.

### CROSS-REFERENCE TO RELATED APPLICATIONS

This applications claims priority to U.S. Prov. Pat. App. No. 61/877,690, filed on Sep. 13, 2013, the entire contents of which are expressly incorporated herein by reference.

### STATEMENT RE: FEDERALLY SPONSORED RESEARCH/DEVELOPMENT

Not Applicable

### BACKGROUND

The various embodiments and aspects disclosed herein relate to a credit card terminal for a vending machine.

Vending machines have a mechanism for dispensing a product or service upon receipt of a payment. Typically, the vending machines have a controller at the vending machine and a credit card terminal which coordinates a credit card payment and the activation of the vending machine. Throughout the day, numerous transactions may take place automatically without the owner's involvement. Unfortunately, these systems still suffer from various operational and functional deficiencies discussed herein.

Accordingly, there is a need in the art for an improved system for vending products and services.

### BRIEF SUMMARY

An upgrade card system is disclosed which replaces a prior art credit card system. Typically, the upgrade card system and the prior art credit card system is the unit or component of the vending machine that communicates with a financial institution to complete a transaction. The prior art credit card system is typically located within the vending machine itself. The upgrade card system may now be located within the convenience store. The upgrade card system provides for additional operations and functions which were not available from the prior art credit card system. The upgrade card system reroutes all peripheral components of the vending machine such as the card reader, printer, display and keypad through the upgrade card system which then either passes signal from a controller through the upgrade card system to the peripheral units or bypasses the controller to directly control the peripheral units. In this manner, additional functionality and operations are enabled. The upgrade card system additionally has communications lines through a traditional phone line and/or the internet to enable financial transactions.

More particularly, a vending machine capable of receiving credit card payment or a fleet card payment is disclosed. The vending machine may comprise a card system, a card reader, a display, optional audio output, a keypad, a printer and a controller. The card system may have an internet communication channel for authorizing the credit card payment or the fleet card payment. The card reader may be in direct communication with the card system for reading numbers on a credit card or a fleet card. The display may be in direct communication with the card system for prompting a user for information. The printer may be in direct communication with the card system for outputting a receipt. The keypad may be in direct communication with the card system for receiving user input. The controller may be in communication with a vending mechanism for vending a product and in direct communication with the card system for selectively dispensing a vended product through the vending mechanism.

The controller controls the display and keypad by relaying control signals through the card system to the display and keypad. The controller receives information from the card reader and the keypad by relaying information from the card reader and keypad to the controller through the card system to the controller when processing a credit card transaction. The card system directly controls the display and keypad and the card system receives information from the card reader and the keypad when processing a fleet card transaction.

The vending machine may further comprise a plurality of vending machines in communication with each other. One of the card systems of the plurality of vending machines may be set up as a server whereas the remaining card systems of the vending machines may be set up as a client so that all credit card transactions are authorized with the server card system.

The machine may allow for the user to set configuration settings of the controller through a web browser in communication with the controller by way of the card system.

The card system of the machine may send reports and alerts to designated email or text message recipients.

In another aspect, a method of accepting payments with a credit card or with a fleet card on a vending machine is disclosed. The method may comprise the steps of swiping a card reader with a card; transmitting information read by the card reader to a card system; processing the information in the card system to determine whether the card is a fleet card or a credit card. If the card is a credit card, then the following steps are performed, namely, (1) sending information to the controller received from a card reader and keypad through the card system; (2) sending information to the display and the printer originating from the controller through the card system; (3) authorizing the credit card over the internet or a modem line. If the card is a fleet card, then the following steps are performed, namely, (1) receiving information from the card reader and the keypad with the card system; (2) sending information to the display and the printer originating from the card system; (3) authorizing the fleet card over the internet or a modem line.

In another aspect, a method of accepting payments with a credit card or with a fleet card on a vending machine is disclosed. The method may comprise the steps of swiping a card reader with a card; transmitting information read by the card reader to a card system; processing the information in the card system to determine whether the card is a fleet card or a credit card; receiving information from the card reader and the keypad with the card system; sending information to the display and the printer originating from the card system; and authorizing the fleet card over the internet or a modem line.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a first embodiment of a prior art credit card terminal system;

FIG. 2 is a flow chart of a second embodiment of a prior art credit card terminal system;

FIG. 3 is a flow chart of the upgrade card system incorporated into the prior art credit card terminal system shown in FIG. 1;

FIG. 4 is a flow chart of an upgrade card system incorporated into the prior art credit card terminal system shown in FIG. 2;

FIG. 5 is a flow chart illustrating steps of the upgrade card system when incorporated into the prior art credit card terminal system shown in FIGS. 1 and 2 for processing credit card payments and fleet cards;

FIG. 6 illustrates a schematic of the upgrade card system providing internet access to the upgrade card system and a controller of the prior art credit card terminal systems shown in FIGS. 1 and 2; and

FIG. 7 is a schematic of a plurality of upgrade card systems connected to each other in a client-server configuration.

### DETAILED DESCRIPTION

Referring now to drawings, an upgrade card system 10 is disclosed which interfaces with an existing controller 12a or 12b of a vending machine 14 for providing additional functionality to operators of existing vending machines 14. The upgrade card system 10 provides for additional functionality by replacing the existing card system with the upgrade card system 10. In doing so, the vending machine 14 is now able to accept other types of payment systems (e.g., fleet cards) and also provides remote capabilities of configuring and receiving alerts and reports from the controller 12a or 12b and the upgrade card system 10. The upgrade card system 10 interfaces with the controller 12a or 12b and other peripheral devices of the vending machine 14 that were previously controlled by the controller 12.

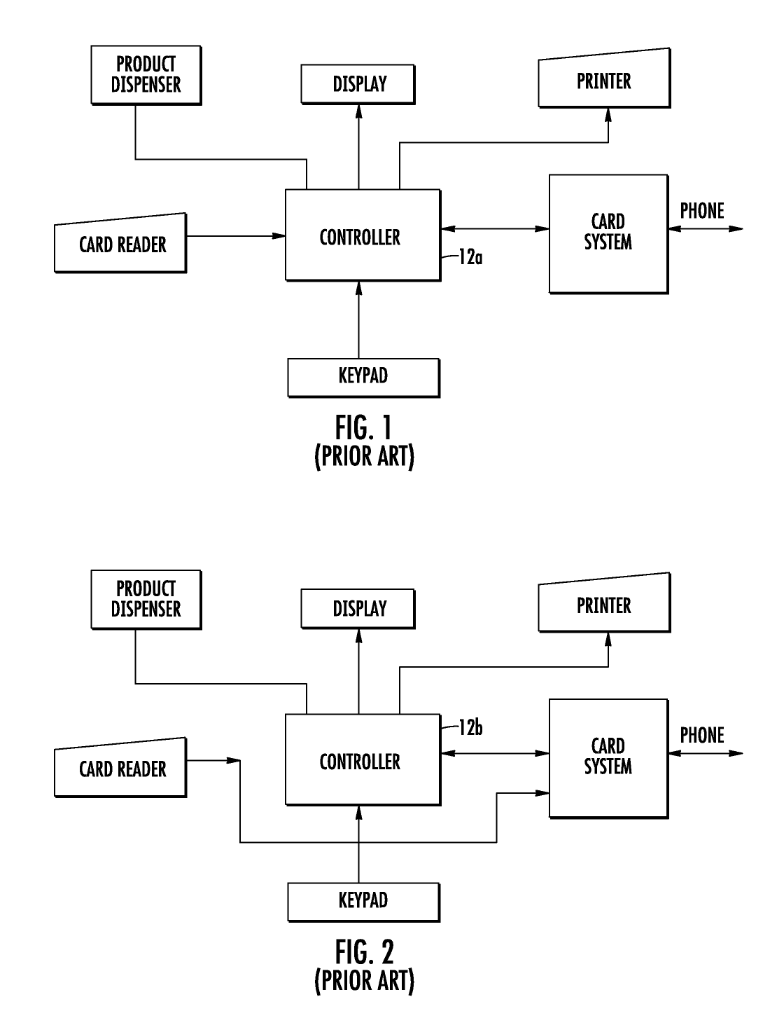

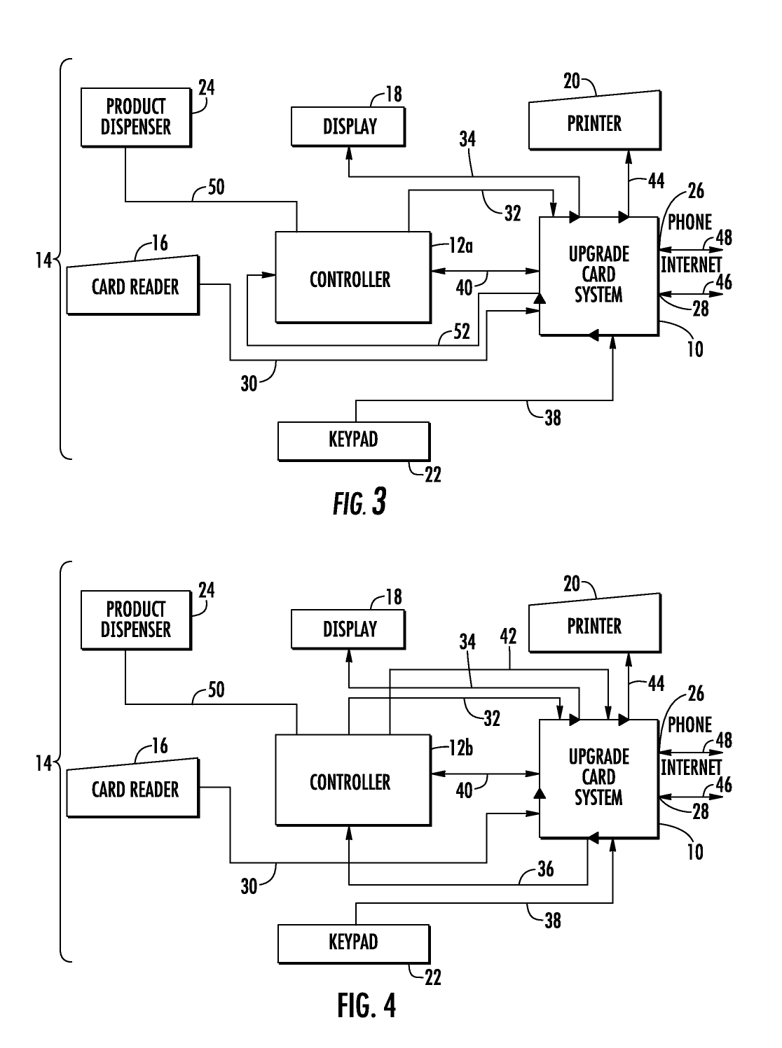

Referring now to FIGS. 1 and 2, prior art vending machine systems are shown. In FIG. 1, a user swipes a credit card into a card reader. The card reader may be located near, on or within the vending machine. The card reader reads the card number and transmits that information to the controller. The controller may provide visual and/or audio prompts to the user on the display to select a product to be dispensed from the vending machine. The user enters the selection by way of the keypad or other pushbuttons. Once the selection is made, the controller has the credit card number and the amount to be charged. The controller 12a transmits this information to the card system. The card system reaches out to a financial institution to obtain authorization for the credit card charge. Once the credit card charge is authorized, the card system transmits a signal to the controller indicating that the credit card charge is authorized. The controller sends a signal to the vending machine to vend the product or service and also sends a signal to the printer to print a receipt if desired by the user.

FIG. 2 is a different prior art vending machine system in which the card reader does not communicate directly with the controller but communicates directly with the card system. In this instance, the card reader reads a credit card number from a credit card. The credit card number is transmitted to the card system. The card system upon receiving the credit card number queries the controller for the amount to be charged. The controller may prompt the user to select a product to be dispensed from the vending machine by way of the display. The user enters a selection by way of the keypad or other pushbuttons. Once the selection is made, the controller sends the amount to be charged based on the user's selection to the card system. The card system reaches out to the financial institution to obtain authorization for the charge. Upon receiving authorization, the card system sends a signal to the controller indicating that the credit card charge is authorized. The controller may also send a signal to the printer to print a receipt if desired by the user.

The prior art systems shown in FIGS. 1 and 2 do not allow for fleet cards and other payment systems. Rather, these systems are limited to credit card transactions and special keypad codes that may be purchased from the cashier to operate the vending machine. Additionally, the prior art systems shown in FIGS. 1 and 2 may have no alert features and do not allow for remote access. The phone line connection is may solely be used for managing credit card transactions.

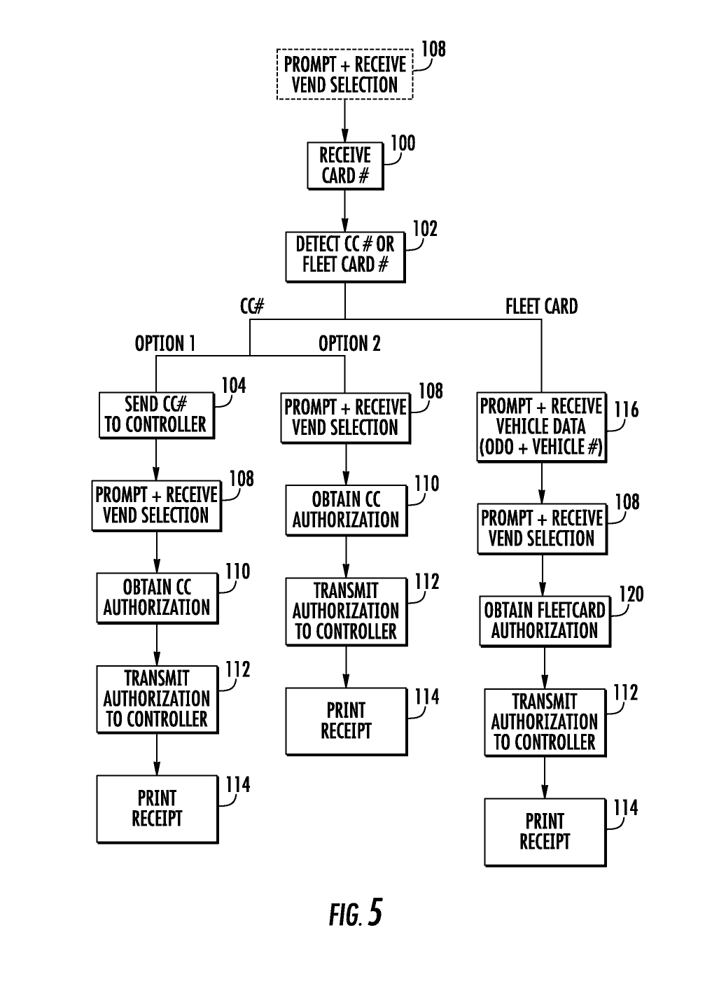

Referring now to FIGS. 3 and 4, two different controllers 12a or 12b are shown which can interface with the upgrade card system 10. In FIG. 3, the upgrade card system 10 is configured to operate with the controller 12a. The controller 12a operates similar to the controller shown in FIG. 1. In FIG. 4, the upgrade card system 10 is configured to operate with the controller 12b. The controller 12b operates similar to the controller shown in FIG. 2.

Referring now to FIG. 3, a first embodiment of a vending machine 14 with the upgrade card system 10 is shown. The peripheral units such as the card reader 16, display 18, printer 20 and keypad 22 are in direct electrical communication with the upgrade card system 10 to receive information from the peripheral units and/or to transmit information to the peripheral units. The controller 12, display 18, printer 20, card reader 16 and the keypad 22 are located near the product dispenser 24. The product dispenser 24 may be a garage access gate, car wash, fuel dispenser, food dispenser, vending machine, and any type of automatic machine operated upon payment of a monetary fee or other payment mechanism. The upgrade card system 10 is typically located within the vending machine but may also be located inside of a convenience store. The upgrade card system 10 processes the payment.

The upgrade card system 10 can be configured to operate with controller 12a or controller 12b. In particular, the upgrade card system 10 can have a physical switch or configuration setting to choose either option 1 or option 2 shown in FIG. 5 when processing a credit card transaction.

The upgrade card system 10 may have two communication ports 26, 28. The communication port 26 may be in communication with a phone line so that the upgrade card system 10 can conduct credit card authorizations and fleet card authorizations through traditional phone line communications. The communication port 28 may be a coaxial connector or a CAT 5 connector used for providing Internet access by way of cable or a digital subscriber line (DSL). The communication port 28 provides a preferred means of obtaining credit card and fleet card authorizations instead of the phone line. The phone line connected to the communication port 26 may function as a backup system in the event that Internet access is disrupted.

The upgrade card system 10 may also have additional connectors for providing communication between the card reader 16, display 18, printer 20 and the keypad 22. As discussed above, the peripheral units 16, 18, 20 and 22 are located near the product dispenser 24 where the customer or user of the vending machine 14 is making payment. The upgrade card system 10 is located typically within the vending machine but may also be located in a separate building such as the convenience store on the same premises as the product dispenser. The communication line between the upgrade card system 10 and the peripheral units 16, 18, 20 and 22 may be made with a hardwired connection that is routed between the upgrade card system 10 and the peripheral units 16, 18, 20 and 22. Alternatively, it is also contemplated that the communication between the upgrade card system 10 and the peripheral units 16, 18, 20 and 22 may be established with a wireless connection such as Wi-Fi. The wireless Wi-Fi connection may be encrypted in order to protect the financial transaction. It is contemplated that the upgrade card system 10 may have a transceiver located in the convenience store and connected to the upgrade card system 10. The peripheral units 16, 18, 20 and 22 located at the product dispenser 24 may have a transceiver as well. The transceiver of the product dispenser 24 may be in a wireless communication with the transceiver connected to the upgrade card system 10.

The upgrade card system 10 may also be in communication with the controller 12a with a hardwired connection or a wireless connection. A hardwired connection would require the upgrade card system 10 and the controller 12a to each have a connector which receives a hardwired line that extends from the upgrade card system 10 to the controller 12a. If wireless communication is established between the upgrade card system 10 and the controller 12a, then the controller 12a may communicate with the upgrade card system 10 by way of the transceiver located near the product dispenser 24 which transmits information to the transceiver in communication with the upgrade card system 10.

Referring now to FIGS. 3 and 5, the operation of the vending machine 14 shown in FIG. 3 will be discussed. The user may approach the product dispenser 24 to receive the product dispensed by the vending machine 14. In order to actuate the product dispenser 24, the user may swipe either a credit card or a fleet card into the card reader 16. The card number is transmitted to the upgrade card system 10 by way of communication line 30. The upgrade card system 10 receives 100 the card number and determines 102 whether the card being swiped is either a credit card or a fleet card by inspecting the numbers of the card. In either case, the credit card number or a dummy credit card number is transmitted 104 to the controller 12a since the controller 12a is expecting to receive a credit card number. The credit card information is transmitted 104 to the controller 12a from the upgrade card system 10 by way of communication line 52. In this sense, the upgrade card system 10 emulates or spoofs the controller 12a into operating as it would have as shown in FIG. 1 in the prior art vending machine 14. At this point, the controller 12a drives the transaction and the upgrade card system 10 merely passes information between the controller 12a and the peripheral units 18, 20 and 22. In particular, the controller 12a may prompt the user to enter a selection if the user has not done so yet by sending a text based message to the display 18 through the upgrade card system 10 by way of communication lines 32, 34. The controller receives a vend selection 108.

The controller 12a sends a signal to the upgrade card system 10 via communication line 40 and requests that the upgrade card system 10 obtains 110 credit card authorization from a financial institution by way of the Internet connection line 46. If the Internet connection is interrupted, then the upgrade card system 10 may obtain credit card authorizations through the phone communication line 48. The benefit of having the Internet connection line 46 is that obtaining credit card authorization through the Internet is faster than obtaining credit card authorization through the phone line 48. By way of example and not limitation, the time required to obtain credit card authorization over the Internet may be a few seconds, whereas, the time required to obtain credit card authorization through the phone line 48 may take up to a minute. During peak usage times of the vending machine 14, there may be a number of people waiting to utilize the vending machine 14. If there is an excessive wait time, then obtaining credit card authorization through the phone line may be unacceptably slow. As such, it is preferred that the credit card authorization be through the Internet communication line 46 and if the Internet communication line 46 is interrupted, then the upgrade card system 10 may utilize the phone line 48 as a backup.

Once credit card authorization is received, the upgrade card system 10 transmits 112 the authorization to the controller 12a by way of communication line 40. With this authorization, the controller 12a activates the product dispenser 24 to vend the product by transmitting a signal to the product dispenser by way of communication line 50. The product dispenser 24 may be a carwash, access gate in a parking garage, a gasoline pump, or other vendible product or service. At some point during the transaction, the upgrade card system 10 sends a signal to the printer 20 to print 114 a receipt by way of communication lines 44.

If the card number is a fleet card number upon inspection of the card numbers, the upgrade card system 10 transmits a signal to the display 18 to prompt 116 the user to enter vehicle data. The user enters the vehicle data (e.g., odometer reading and vehicle number) by way of keypad 22. The information entered into the keypad 22 is received 116 by the upgrade card system 10. The controller 10 then prompts 108 the user to provide a vend selection by displaying text on the display 18 by way of communication line 32 and 34 and receive 108 the vend selection. Thereafter, the upgrade card system 10 may obtain 120 the fleet card authorization by communicating with the financial institution by way of the Internet connection line 46 or the phone line 48. Once the fleet card authorization is received, the upgrade card system 10 may transmit 112 the authorization to the controller 12a through communication line 40. The controller 12a may activate the product dispenser 24 to vend the product. At some point during the transaction, the upgrade card system 10 may send a signal to the printer 20 to print 114 a receipt through communication line 44.

In FIG. 3, the controller 12a drives the entire transaction with the user when a credit card is involved. However, when the card being swiped is a fleet card, the upgrade card system 10 spoofs the controller 12a into thinking that a credit card transaction is being made and drives the rest of the transaction with the user and the financial institution.

Referring now to FIG. 4, the upgrade card system 10 can interface with controller 12b which operates in a similar fashion to that shown in FIG. 2. Referring now to FIGS. 4 and 5, the operation of the vending machine 14 is as follows. The user swipes a card in the card reader 16. The card number is transmitted and received 100 by the upgrade card system 10 through communication line 30. The upgrade card system 10 detects whether the card being swiped is a credit card number or fleet card number based on the numbers themselves. If the card being swiped is a credit card, then the upgrade card system 10 proceeds through option two shown in FIG. 5. In particular, the controller 10 prompts 108 the user to enter a vend selection by displaying text on the display 18. The controller sends a signal to the display 18 via the upgrade card system through communication lines 32 and 34. The controller receives a vend selection 108. The controller 12a sends a signal to the upgrade card system 10 via communication line 40 and requests that the upgrade card system 10 obtains 110 credit card authorization from a financial institution. The upgrade card system 10 obtains 110 credit card authorization by reaching out to the financial institution by way of the phone line 48 through a communication port 26 or preferably the Internet connection line 46 through communication port 28. Once the upgrade card system 10 receives the credit card authorization from the financial institution, the upgrade card system 10 transmits 112 the authorization to the controller 12 through communication line 40. The controller 12 activates the product dispenser 24 to dispense the product or service by sending a signal through communication line 50. The controller 12b also transmits a signal to the printer 20 to print 114 a receipt by sending a signal through communication lines 42, 44.

If the card being swiped is a fleet card then the upgrade card system 10 processes the transaction as described above in relation to FIG. 3 and the fleet card option shown in FIG. 5. A special receipt specific to fleet cards can be printed on the printer 20 by the upgrade card system via communication line 44.

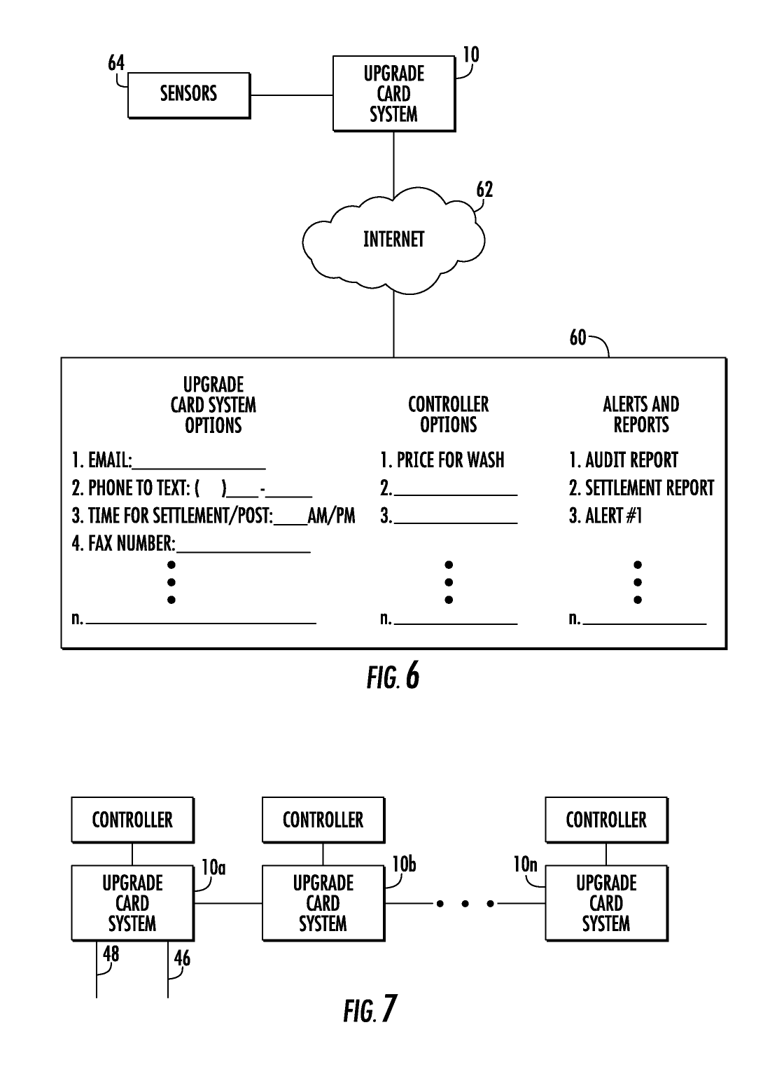

In another aspect, the upgrade card system 10 allows an operator of the vending machine 14 to remotely configure the controller 12a or 12b and also configure the upgrade card system 10. In particular, the upgrade card system 10 may be connected to the internet. The operator may access a web address of the upgrade card system 10 by way of a web browser 60, as shown in FIG. 6. The web browser 60 accesses the configuration options of the upgrade card system and the controller options. The upgrade card system options include but are not limited to an email address, phone number to text and/or fax number where reports and alerts may be sent to. The upgrade card system may also provide an option to set the time of day to run a settlement or post. The upgrade card system may have a number of other options for configuration which can be accessed remotely through the web browser 60. The web browser can also access the configuration options of the controller 12 by way of the upgrade card system 10. The upgrade card system interfaces with the controller 12 so that the upgrade card system 10 can configure the options of the controller 12. The upgrade card system is also connected to the internet 62. The web browser 60 accesses the configuration settings of the controller by way of the upgrade card system. The controller options may include information as to the price of one or more of the vend selections and other options as well.

The vending machine 14 may have one or more sensors 64. By way of example and not limitation, the sensors 64 may sense a low change status, out of soap status, or other status related to the operation of the product dispenser 24 or other aspects of the vending machine. The sensors 64 may send a signal to the upgrade card system 10 directly or through the controller 12. The upgrade card system 10 may send the alert in any preferred manner set up by the operator. By way of example and not limitation, the alerts may be sent through email, text to the phone number listed in the upgrade card system or fax number.

The upgrade card system 10 may be set up as a client server situation. When there are multiple product dispensers 24 (e.g., multiple car washes or fuel pumps), each one of the product dispensers will have a controller and an upgrade card system. A first upgrade card system 10a may have the internet and phone line 46, 48, so as to be set up as a server while the remaining upgrade card systems 10b-10n are set up as a client to the first upgrade card system. When authorizations are being made, all authorizations are being made through first upgrade card system. Additionally, all reports and alerts are sent out to the intended recipients through the first upgrade card system. The web browser 60 may access the server and client upgrade card systems and controllers to configure the options for these components.

The above description is given by way of example, and not limitation. Given the above disclosure, one skilled in the art could devise variations that are within the scope and spirit of the invention disclosed herein, including various ways of communicating between the upgrade card system and the controller. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A vending machine capable of receiving credit card payment or a fleet card payment, the vending machine comprising:
a card system having an internet communication channel for authorizing the credit card payment or the fleet card payment;
a card reader in direct communication with the card system for reading numbers on a credit card or a fleet card;
a display in direct communication with the card system for prompting a user for information;
a printer in direct communication with the card system for outputting a receipt;
a keypad in direct communication with the card system for receiving user input; and
a controller in communication a vending mechanism for vending a product and in direct communication with the card system for selectively dispensing a vended product through the vending mechanism;
wherein the controller controls the display and keypad by relaying control signals through the card system to the display and keypad and the controller receives information from the card reader and the keypad by relaying information from the card reader and keypad to the controller through the card system to the controller when processing a credit card transaction, and the card system directly controls the display and keypad and the card system receives information from the card reader and the keypad when processing a fleet card transaction.

2. The machine of claim 1 further comprising a plurality of vending machines in communication with each other, one of the card systems of the plurality of vending machines set up as a server whereas the remaining card systems of the vending machines set up as a client so that all credit card transactions are authorized with the server card system.

3. The machine of claim 1 wherein a user sets configuration settings of the card system and the controller through a web browser in communication with the controller by way of the card system.

4. The machine of claim 1 wherein the card system sends reports and alerts to designated email or text message recipients.

5. A method of accepting payments with a credit card or with a fleet card on a vending machine, the method comprising the steps of:
swiping a card reader with a card;
transmitting information read by the card reader to a card system;
processing the information in the card system to determine whether the card is a fleet card or a credit card;
if the card is a credit card, then performing the following steps:
sending information to the controller received from a card reader and keypad through the card system; and
sending information to the display and the printer originating from the controller through the card system;
authorizing the credit card over the internet or a modem line;
if the card is a fleet card, then performing the following steps:
receiving information from the card reader and the keypad with the card system;
sending information to the display and the printer originating from the card system;
authorizing the fleet card over the internet or a modem line.

6. A method of accepting payments with a credit card or with a fleet card on a vending machine, the method comprising the steps of:
swiping a card reader with a card;
transmitting information read by the card reader to a card system;
processing the information in the card system to determine whether the card is a fleet card or a credit card;
receiving information from the card reader and the keypad with the card system;
sending information to the display and the printer originating from the card system;
authorizing the fleet card over the internet or a modem line.
